(19) United States
(12) Patent Application Publication
(10) Pub. No.: US 2015/0177454 A1
(43) Pub. Date: Jun. 25, 2015

(54) COVERLESS LINEAR LIGHT SOURCE LIGHT GUIDE WITH LIGHT REFLECTING PATTERNED SURFACE

(71) Applicant: PIXON TECHNOLOGIES CORP., Taipei Hsien (TW)

(72) Inventors: YEN-CHIEH CHEN, TAIPEI HSIEN (TW); SHIH CHE CHEN, TAIPEI HSIEN (TW); CHIEN LIANG LIAO, TAIPEI HSIEN (TW)

(73) Assignee: PIXON TECHNOLOGIES CORP., Taipei Hsien (TW)

(21) Appl. No.: 14/138,830

(22) Filed: Dec. 23, 2013

(51) Int. Cl. F21V 8/00; F21K 99/00

(52) U.S. Cl. CPC G02B 6/0096; F21K 9/52; F21Y 2103/003

(57) ABSTRACT

A coverless linear light source light guide with a light reflecting patterned surface that eliminates the need for a reflective cover is discloses. The light guide comprises an elongated polygonal transparent material. The light reflecting patterned surface comprises a plurality of peaks and a plurality of valleys with a valley disposed between each peak. As the light reflecting patterned surface extends along the light guide the depth of each valley increases and the width of the floor of each valley narrows. Closest to the light receiving end the valley depth is shallowest, the valley floor width is widest, and the height of the peak from the valley floor is shortest. Farthermost away, the valley depth is deepest, the valley floor is narrowest, and the height of the peak from the valley floor is the tallest.

### BACKGROUND OF THE INVENTION

1. Field of the Invention

The present invention relates to lighting devices. More specifically, the present invention discloses a linear light source light guide with a light reflecting patterned surface that evenly distributes light through the light guide to effectively emit a uniform light and eliminates the need for a reflective cover around the light guide.

2. Description of the Prior Art

Linear light sources are used in scanners to light to illuminate an object. When the object is illuminated, the scanner is able to acquire an image of the object.

However, the performance of the linear light source greatly affects the quality of the acquired image. If the emitted light is not uniform or varies in intensity, the object will not be effectively lit and the acquired image will be of inferior quality with areas of the object too light and areas of the object too dark.

In an attempt to improve the quality of the emitted light the conventional linear light source has a reflective cover surrounding a light pipe to prevent light from escaping the light pipe except for a small opening in the reflective cover where the light is emitted.

While somewhat effective in certain applications, the addition of the reflective cover increase production costs. For example, more material is required so material costs increase, additional tooling is required to create the reflective cover so manufacturing costs increase, more production personnel are required to produce the cover so labor costs increase, and additional time and labor is required to assemble the light pipe inside the reflective cover so assembly costs increase. As a result the conventional linear light source is not as cost effective as current demands require. To remain competitive in the market, light sources need to be smaller and less expensive to manufacture.

Therefore, there is need for an improved cost effective linear light source with superior light intensity and light uniformity that utilizes a light guide with a light reflecting patterned surface that eliminates the need for a reflective cover.

### SUMMARY OF THE INVENTION

To achieve these and other advantages and in order to overcome the disadvantages of the conventional method in accordance with the purpose of the invention as embodied and broadly described herein, the present invention provides a coverless linear light source light guide with light reflecting patterned surface for effectively and efficiently providing uniform light.

The present invention provides a coverless linear light source with improved light uniformity and light intensity without needing or using a reflective cover or housing around the light guide. Eliminating the reflective cover or housing reduces production costs including labor, material, tooling, inventory, and assembly costs as well as reducing manufacturing complexity thus saving time. This is an advantage of the present invention

The coverless linear light source comprises a light guide and a light emitting diode (LED) module. The light guide comprises an elongated polygonal transparent material. On the light receiving end of the light guide is a hooded bracket for holding the LED module and connecting the LED module and the light guide together.

The light guide further comprises a light emitting surface where light exits the light guide and a light reflecting patterned surface for reflecting light towards the light emitting surface.

The light reflecting patterned surface comprises a plurality of peaks and a plurality of valleys with a valley disposed between each peak.

As the light reflecting patterned surface extends along the light guide the depth of each valley increases. At the pattern start, which is closest to the LEDs, the depth of the valley is shallowest and the height of the peak from the floor of the valley is the shortest.

As the light reflecting patterned surface continues away from the LEDs the depth of the valley gradually increases and the height of the peak from the floor of the valley continues to gradually increase.

At the pattern end, which is farthermost away from the LEDs, the depth of the valley is deepest and the height of the peak from the floor of the valley is the tallest.

At the pattern end the floor of the valley is narrowest and the pattern is or approaches a sawtooth pattern where the valley is or approaches a v-shape. Moving towards the LEDs the floor of the valley becomes flat and gradually widens. At the pattern start 230 the floor of the valley is widest.

When power is applied conductive pins of the LED module, which are electrically connected to LEDs, the LEDs illuminate and emit light into the light receiving end of the light guide. The light travels or propagates through the light guide and is reflected by the light reflecting patterned surface towards the light emitting surface of the light guide and the light exits the light guide through the light emitting surface.

A plurality of side surfaces are disposed between the light emitting surface and the light reflecting patterned surface.

A side groove and a top groove are provided for allowing the light guide to be held to a main housing of the scanner sub-module. The main housing's side clips hold the side groove and top clips hold the top groove.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is an isometric view drawing illustrating a light guide of a coverless linear light source according to an embodiment of the present invention;

FIG. 2A is a cross-sectional view drawing illustrating a light guide of a coverless linear light source according to an embodiment of the present invention;

FIG. 2B is a cross-sectional view drawing illustrating a light guide of a coverless linear light source according to an embodiment of the present invention;

FIG. 3A is a drawing illustrating a light guide with a hooded bracket according to an embodiment of the present invention;

FIG. 3B is an exploded view drawing illustrating a light guide and light emitting diode module of a coverless linear light source according to an embodiment of the present invention;

FIG. 3C is a drawing illustrating a light emitting diode module with module grasps according to an embodiment of the present invention;

FIG. 3D is a drawing illustrating a light emitting diode module with module grasps according to an embodiment of the present invention;

FIG. 3E is a drawing illustrating a coverless linear light source according to an embodiment of the present invention;

FIG. 3F is a drawing illustrating a coverless linear light source according to an embodiment of the present invention;

FIG. 4A is a bottom view drawing of a coverless linear light source with a light guide with a light reflecting patterned surface according to an embodiment of the present invention;

FIG. 4B is a cross-sectional view drawing of a coverless linear light source with a light guide with a light reflecting patterned surface according to an embodiment of the present invention;

FIG. 5A is a top view drawing of a coverless linear light source according to an embodiment of the present invention;

FIG. 5B is a side view drawing of a coverless linear light source according to an embodiment of the present invention;

FIG. 5C is a drawing illustrating a coverless linear light source according to an embodiment of the present invention;

FIG. 6A is a cross-sectional side view drawing illustrating light paths of the light guide with light reflecting patterned surface according to an embodiment of the present invention;

FIG. 6B is a cross-sectional drawing illustrating light paths of the light guide with light reflecting patterned surface according to an embodiment of the present invention;

FIG. 6C is a cross-sectional drawing illustrating emitted light paths of the light guide according to an embodiment of the present invention;

FIG. 7A is a drawing illustrating a coverless linear light source, lens array, main housing, and printed circuit board according to an embodiment of the present invention;

FIG. 7B is a drawing illustrating a coverless linear light source, lens array, and main housing according to an embodiment of the present invention;

FIG. 7C is a top view drawing illustrating a coverless linear light source, lens array, and main housing according to an embodiment of the present invention; and

FIG. 7D is a cross-sectional drawing illustrating a coverless linear light source, lens array, printed circuit board, and main housing according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

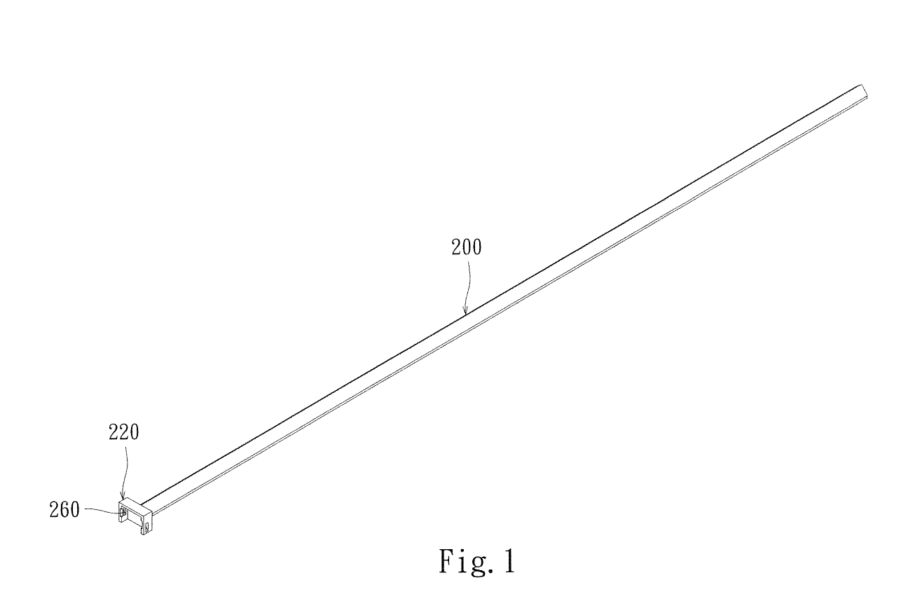

Refer to FIG. 1, which is an isometric view drawing illustrating a light guide of a coverless linear light source according to an embodiment of the present invention.

The light guide 200 comprises an elongated polygonal transparent material. Light enters an end of the light guide 200 and is reflected by a patterned surface of the light guide 200. The light eventually exits the light guide through a light emitting surface of the light guide 200.

The light guide 200 further comprises a hooded bracket 220 with hood grasps 260. The hooded bracket 220 is disposed on the light receiving end of the light guide 200. A light emitting diode (LED) module fits into the hooded bracket 220 and is held by the hood grasps 260.

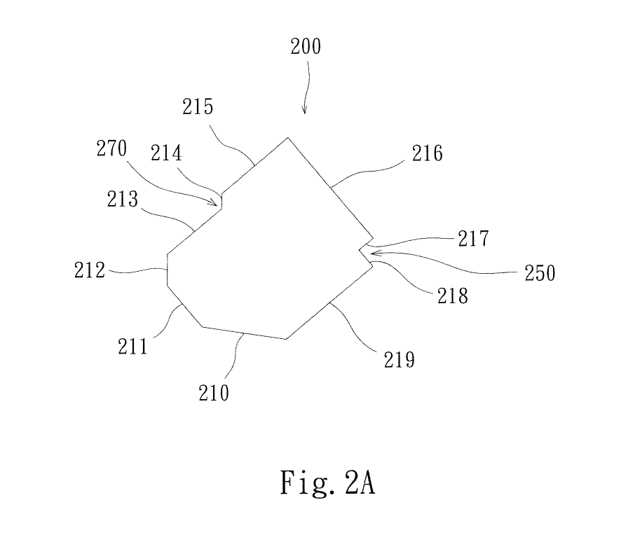

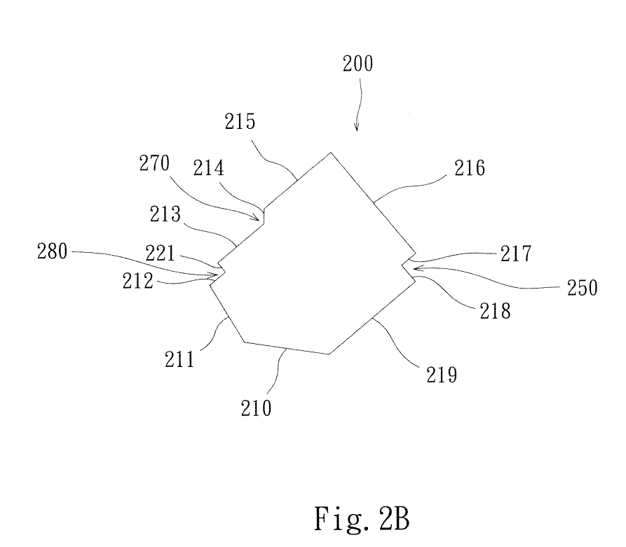

Refer to FIG. 2A, which is a cross-sectional view drawing illustrating a light guide of a coverless linear light source according to an embodiment of the present invention.

In the embodiment illustrated in FIG. 2A the light guide 200 comprises a light reflecting patterned surface 210 for reflecting light towards a light emitting surface 216 and the reflected light exits the light guide 200 via the light emitting surface 216.

A side groove 250 comprises a two-sided notch disposed on the right corner of the light emitting surface 216. The side groove 250 comprises a side groove upper surface 217 and a side groove lower surface 218. A side clip of a main housing extends into the side groove 250 and grasps the side groove lower surface 218 to hold the light guide 200 in a main housing. The side groove upper surface 217 contacts the right corner of the light emitting surface 216 and the side groove lower surface 218 contacts a top corner of a right side surface 219.

A top groove 270 comprises a two-sided obtuse angle notch. The top groove 270 comprises a top groove upper surface 214 and a top groove lower surface 213. A top clip of a main housing extends into the top groove 270 and grasps the top groove lower surface 213 to hold the light guide 200 in a main housing. The top groove upper surface 214 contacts a bottom corner of a left side surface 215 and the top groove lower surface 213 contacts a top corner of an angled side surface 212.

A plurality of side surfaces are disposed between the light reflecting patterned surface 210 and the light emitting surface 216.

A right side surface 219 is disposed between the side groove lower surface 218 of the side groove 250 and the light reflecting patterned surface 210. A left side surface 215 is disposed between the light emitting surface 216 and the top groove upper surface 214 of the top groove 270. A bottom side surface 211 is disposed on a left corner of the light reflecting patterned surface 210. An angled side surface 212 is disposed between the bottom side surface 211 and the top groove lower surface 213.

Refer to FIG. 2B, which is a cross-sectional view drawing illustrating a light guide of a coverless linear light source according to an embodiment of the present invention.

In the embodiment illustrated in FIG. 2B the light guide 200 comprises a left groove 280 disposed on the light guide 200 where the angled side surface (212 FIG. 2A) was positioned. The left groove 280 comprises a left groove upper surface 221 and a left groove lower surface 212. The left groove upper surface contacts the top groove lower surface 213 of the top groove 270. The left groove lower surface contacts the left corner of the bottom side surface 211.

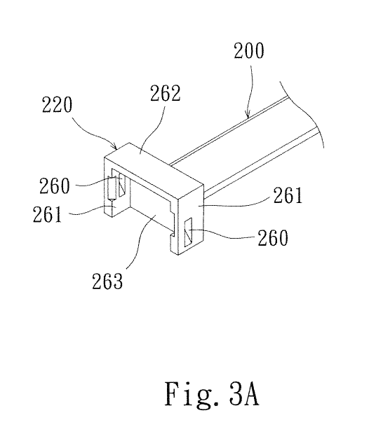

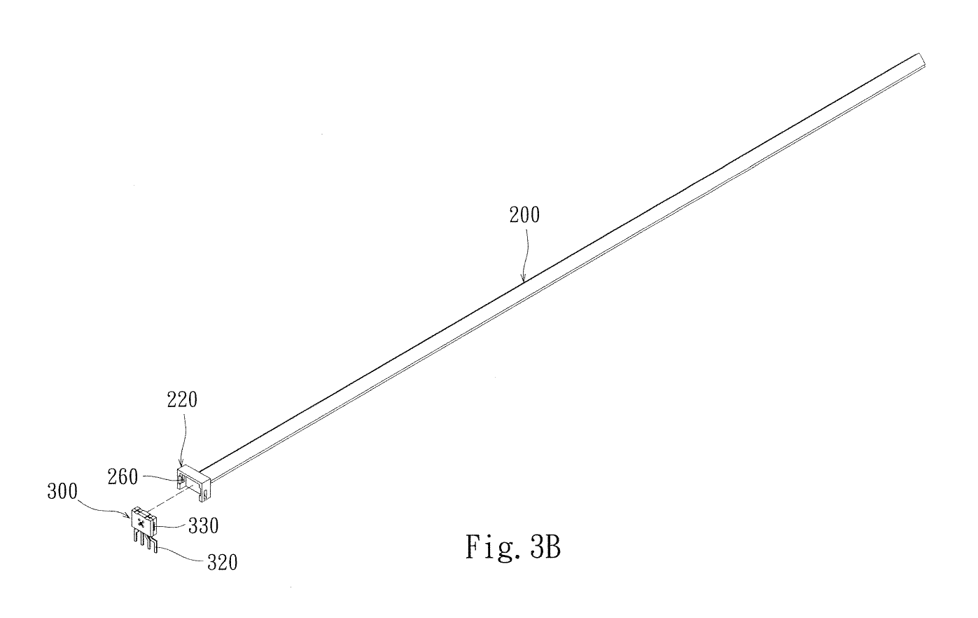

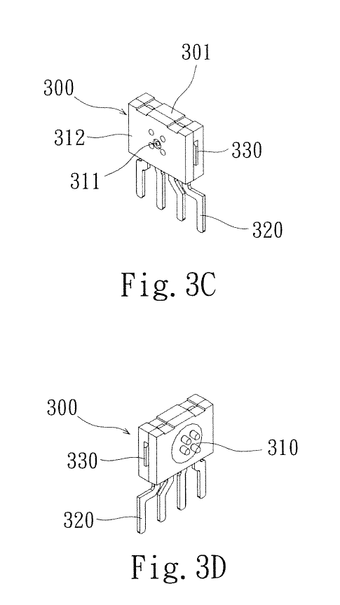

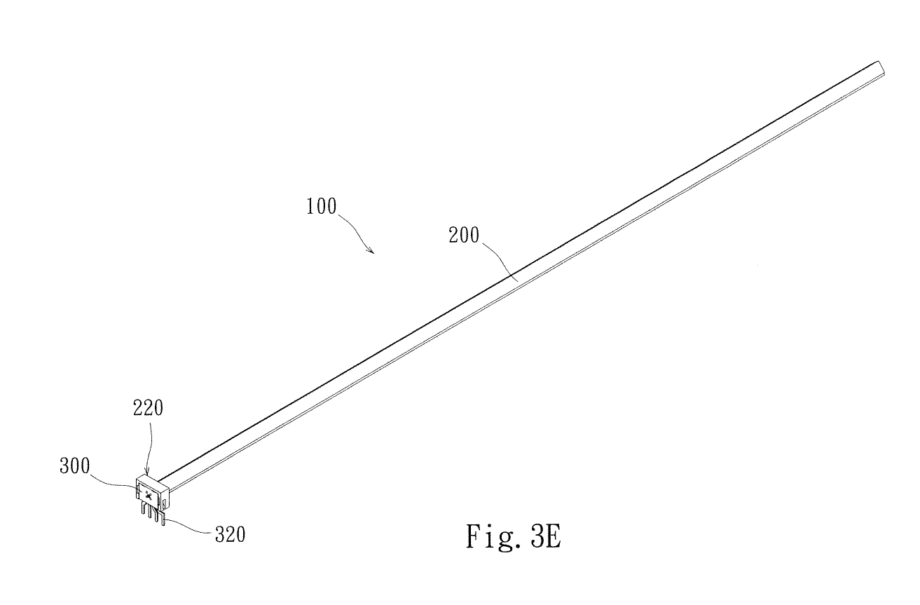

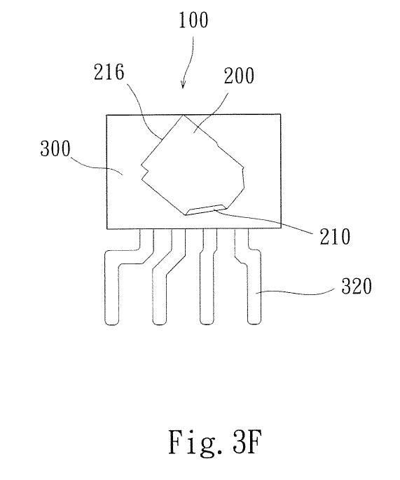

Refer to FIG. 3A, which is a drawing illustrating a light guide with a hooded bracket according to an embodiment of the present invention.

FIG. 3A shows a close up view of the light guide 200 and the hooded bracket 220. The hooded bracket 220 comprises a hood top 262, a hood back 263, two hood sides 261, and two hood grasps 260 disposed in the hood sides 261.

The hood back 263 comprises the light receiving end of the light guide 200 where light enters the light guide 200.

The hood grasp 260 comprises grasping elements, for example, a tab, an ear, a hole, a slot, a groove, an indentation, a post, or a slide rail which mate with grasping elements of a light emitting diode (LED) module.

Refer to FIGS. 3C-3D, which are drawings illustrating a light emitting diode module with module grasps according to an embodiment of the present invention.

The light emitting diode (LED) module 300 comprises a module body comprising a module top 301 and a module back 312. A plurality LEDs 310 are disposed in the front of the module body. A plurality of conductive pins 320 extend below the module body for electrically connecting the plurality of LEDs 310 to conductive traces on a printed circuit board (PCB) in the main housing.

A plurality of heatsinks 311 is disposed in the module back 312 for dissipating heat generated by the LEDs 310.

The LED module 300 further comprises module grasps 330 disposed on sides of the module body. The module grasp 330 comprises grasping elements, for example, a tab, an ear, a hole, a slot, a groove, an indentation, a post, or a slide rail which mate with the hood grasp of the hooded bracket.

Refer to FIG. 3B and FIG. 3E, which are drawings illustrating a light guide and light emitting diode module of a coverless linear light source according to an embodiment of the present invention.

To assemble the coverless linear light source 100 of the present invention the LED module 300 is inserted into the hooded bracket 220 of the light guide 200.

The hood top 262 contacts the module top 301 and the hood sides 261 contact the sides of the module body of the LED module 300. The size of the interior of the hooded bracket 220 is formed to fit and hold the LED module 300 in the hooded bracket 220.

To hold the LED module 300 and the hooded bracket 220 even more securely, the hood grasps 260 mate with the module grasps 330 and attach the LED module 300 and the hooded bracket together.

Since the LED module 300 and the hooded bracket 220 are connected together, the present invention offers a far superior conservation of light emitted by the LED module 300 and entering the light guide 200. Additionally, the hooded bracket 220 maintains the LED module 300 at an optimal angle to the light guide 220 to improve light intensity.

Refer to FIG. 3F, which is a drawing illustrating a coverless linear light source according to an embodiment of the present invention.

When the coverless linear light source 100 is assembled the alignment and positioning of the light guide 200 and the LED module 300 are as shown in FIG. 3F. The light receiving end of the light guide 200 is positioned over the LEDs of the LED module 300. When power is applied to the conductive pins 320 the LEDs illuminate and emit light into the light guide 200. The light travels through the light guide 200 and is reflected by the light reflecting patterned surface 210 and exits the light guide 200 through the light emitting surface 216.

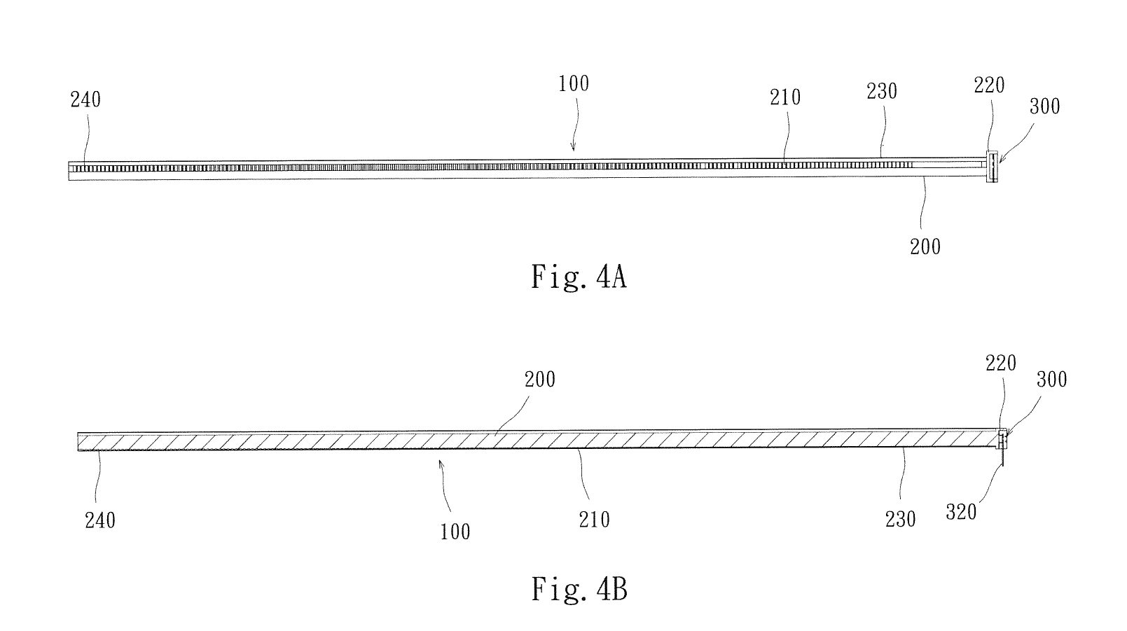

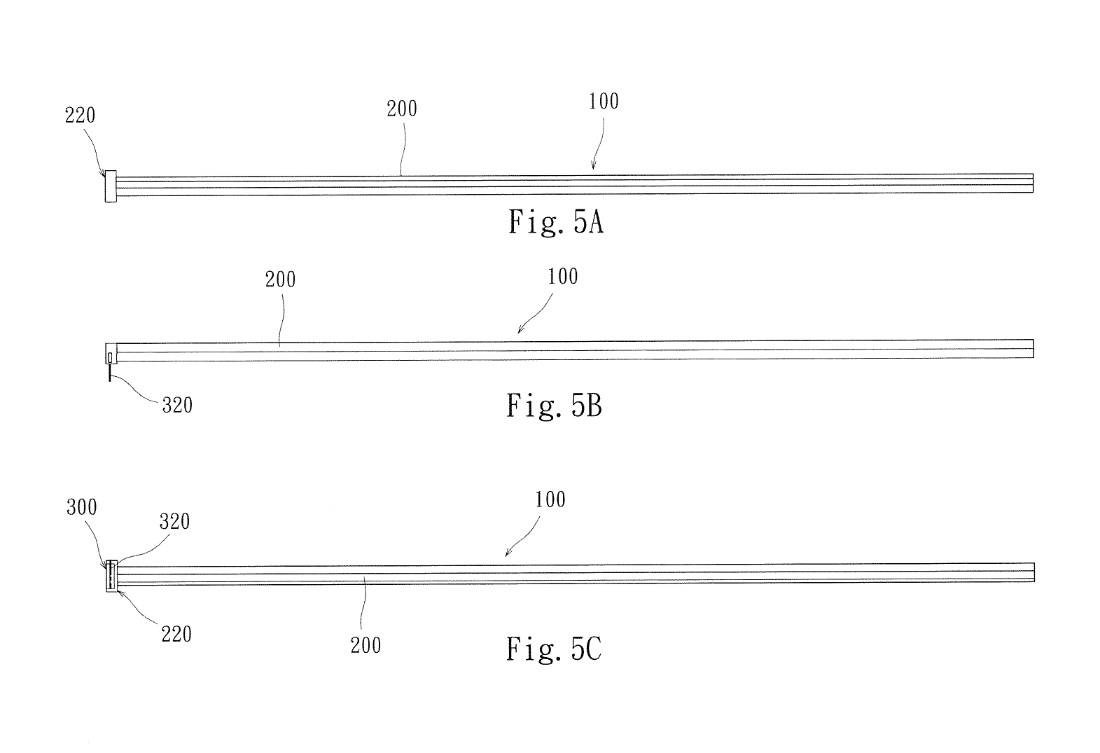

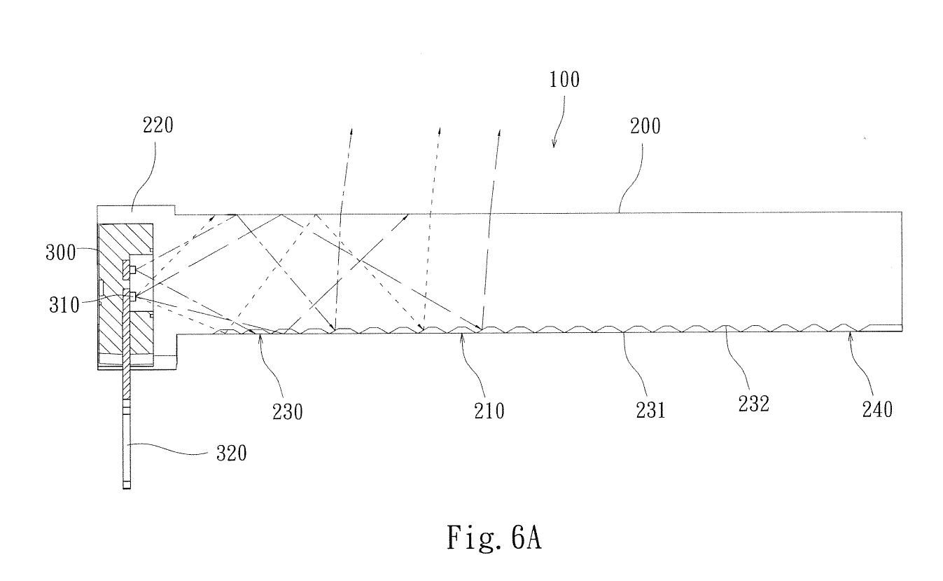

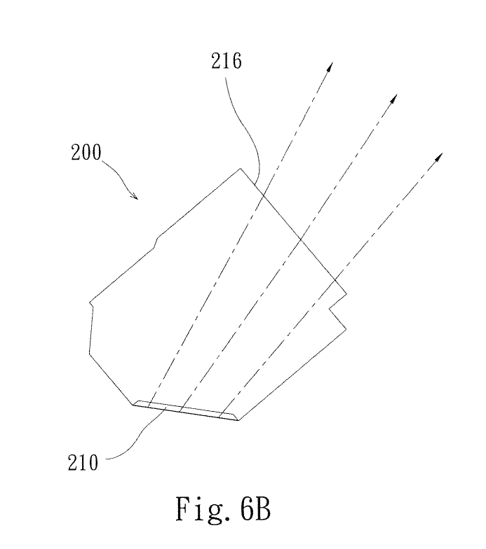

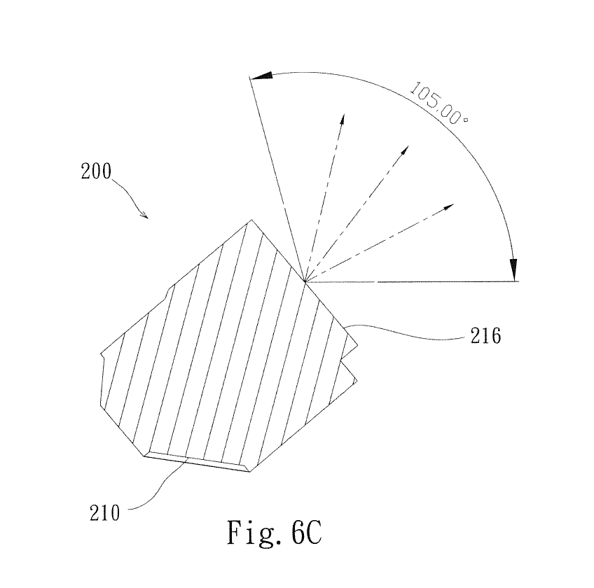

Refer to FIGS. 4A-4B and FIGS. 5A-5C, which are drawings illustrating a coverless linear light source with a light guide with a light reflecting patterned surface according to an embodiment of the present invention, and to FIG. 6A, which is a cross-sectional side view drawing illustrating light paths of the light guide with light reflecting patterned surface according to an embodiment of the present invention.

The light reflecting patterned surface 210 of the light guide 200 comprises a pattern start 230 and a pattern end 240. The pattern start 230 is disposed closest to the hooded bracket 220 and light receiving end of the light guide 200. The pattern end is at the opposite end of the light guide 200 farther away from the light receiving end.

The light reflecting patterned surface 210 comprises a plurality of peaks 231 and a plurality of valleys 232 with a valley 232 disposed between each peak 231.

As the light reflecting patterned surface 210 extends along the light guide 200 the depth of each valley 232 increases. At the pattern start 230, which is closest to the LEDs 310, the depth of the valley 232 is shallowest and the height of the peak 231 from the floor of the valley 232 is the shortest.

As the light reflecting patterned surface 210 continues away from the LEDs 310 the depth of the valley 232 gradually increases and the height of the peak 231 from the floor of the valley 232 continues to gradually increase.

At the pattern end 240, which is farthermost away from the LEDs 310, the depth of the valley 232 is deepest and the height of the peak 231 from the floor of the valley 232 is the tallest.

At the pattern end 240 the floor of the valley 232 is narrowest and the pattern is or approaches a sawtooth pattern where the valley is or close to a v-shape. Moving towards the LEDs the floor of the valley 232 becomes flat and gradually widens. At the pattern start 230 the floor of the valley 232 is widest.

Continue to refer to FIG. 6A and refer to FIG. 6B, which is a cross-sectional drawing illustrating light paths of the light guide with light reflecting patterned surface according to an embodiment of the present invention, and to FIG. 6C, which is a cross-sectional drawing illustrating emitted light paths of the light guide according to an embodiment of the present invention.

When power is applied by the printed circuit board to the conductive pins 320, which are electrically connected to the LEDs 310, the LEDs 310 illuminate and emit light into the light receiving end of the light guide 200. The light travels or propagates through the light guide 200 and is reflected by the light reflecting patterned surface 210 towards the light emitting surface 216 of the light guide 210. Some of the light can be reflected by other sides, for example, the bottom side surface, the right side surface, the left side surface, the angled side surface, the top groove, the side groove, or the left groove prior to being reflected by the light reflecting patterned surface 210.

The light reflected by the light reflecting patterned surface 210 towards the light emitting surface 216 exits the light guide via the light emitting surface 216.

The light paths of the emitted light of the light guide 200 travel in a variety of angles away from the light emitting surface 216. In an embodiment of the present invention as illustrated in FIG. 6C the emitted light shines in a range of, for example, 105 degrees. This field of illumination allows for uniform illumination of the target object to be captured.

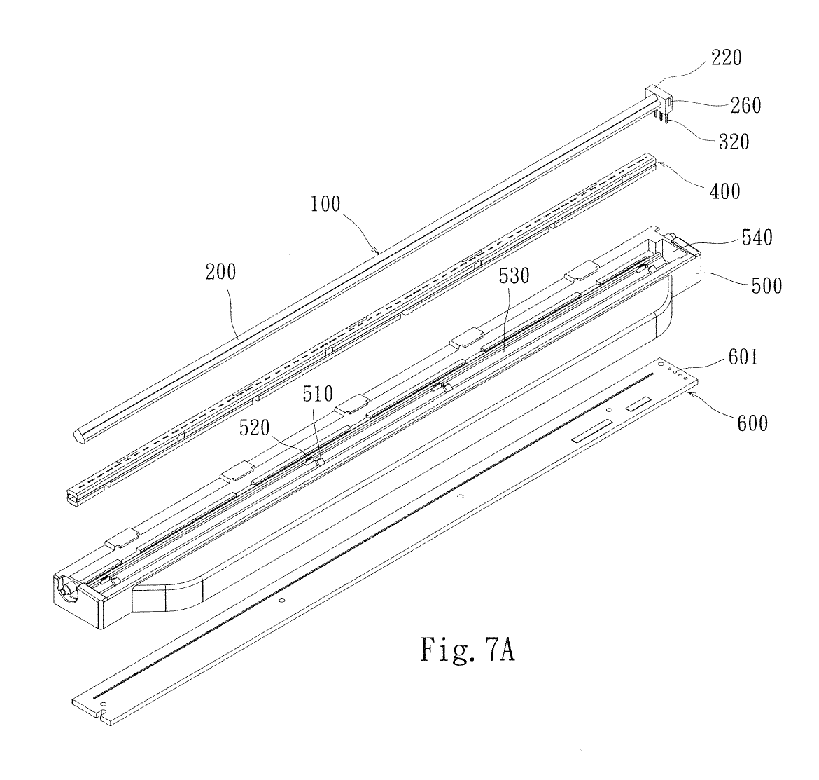

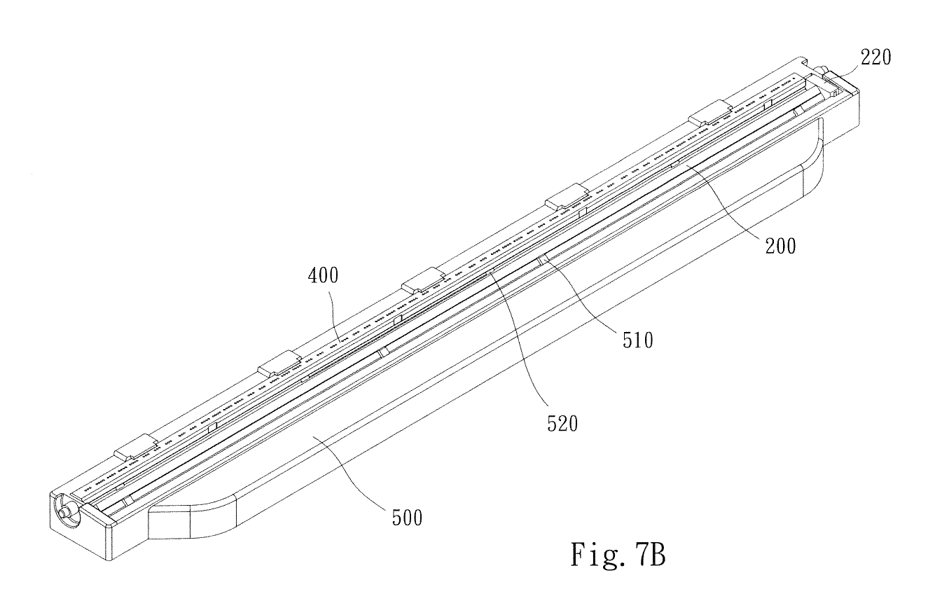

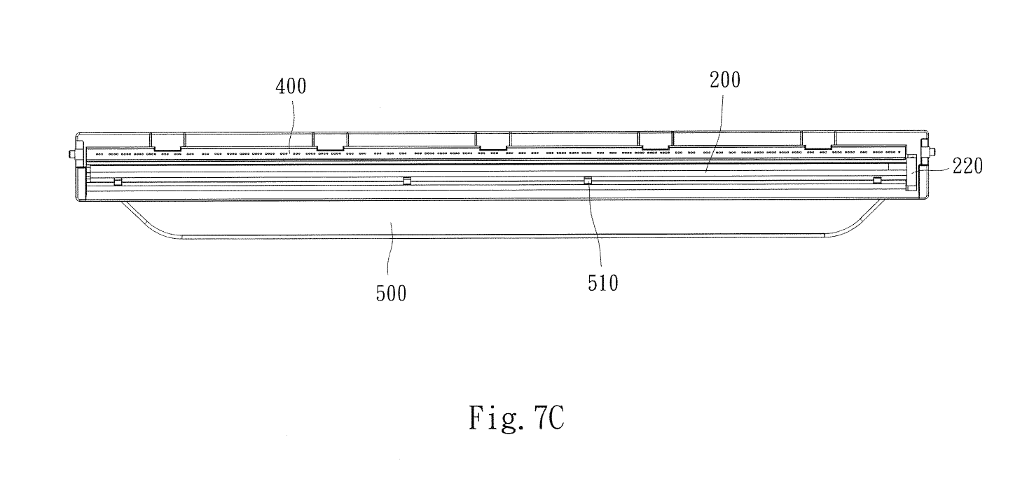

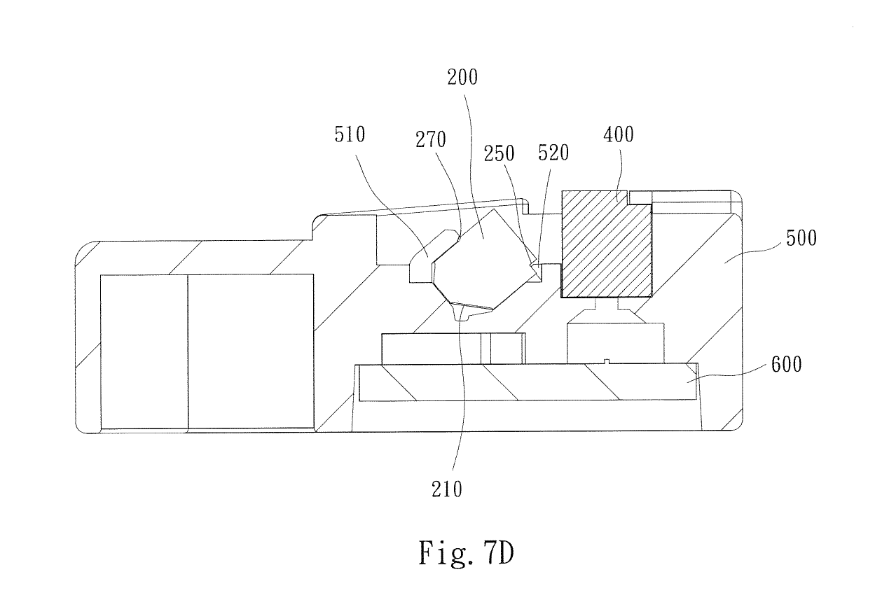

Refer to FIG. 7A-7D, which are drawings illustrating a coverless linear light source, lens array, main housing, and printed circuit board according to an embodiment of the present invention.

The sub-module for a scanner comprises main housing 500, a printed circuit board (PCB) 600, a lens array 400, and the coverless linear light source 100.

The PCB 600 comprises circuitry and electronic devices for controlling the electrical components of the sub-module. The lens array 400 focuses light reflected off of the target object and passes the focused light to sensors below the lens array 400 for capturing an image of the target object.

The main housing 500 holds the components of the sub-module together. The main housing 500 comprises a top clip 510, a side clip 520, a light guide cavity 530, and a hooded bracket cavity 540 all disposed on a top surface of the main housing 500. The top clip 510 and the side clip 520 are disposed on opposite sides of the light guide cavity 530. The hooded bracket cavity 540 is disposed on an end of the light guide cavity 530.

To assemble the sub-module for the scanner, the PCB 600 is inserted into the bottom of the main housing 500 and the lens array 400 is inserted into a top area of the main housing 500.

The coverless linear light source 100 is inserted into the light guide cavity 530 and the hooded bracket cavity 540 with the elongated polygonal transparent section of the light guide 200 inserted into the light guide cavity 530 and the hooded bracket 220 of the light guide 200 inserted into the hooded bracket cavity 540.

The conductive pins 320 of the LED module extend through PCB holes 601 in the PCB 600 and are electrically connected to conductive traces on the PCB 600.

When the light guide 200 is inserted into the light guide cavity 530, the side clips 520 of the main housing 500 enter the side groove 250 of the light guide 200 and grasp the side groove lower surface. Also, the top clips 510 of the main housing 500 grasp and apply pressure against the top groove lower surface of the top groove 270. The top clips 510 apply pressure against the top groove lower surface to push the light guide 200 against the side clips 520 and maintain the side clips 520 in the side groove 250. In this way, the coverless linear light source 100 is securely held in the main housing. Additionally, if required, the coverless linear light source 100 can be removed from the main housing 500 by applying pressure against the top clips 510 to release the side clips 520 from the side groove 250.

In operation the PCB 600 provides power to the conductive pins 320 of the LED module which turns on the LEDs. The LEDs emit light into the hood back of the hooded bracket which is the light receiving end of the light guide 200. The light reflects off of the light reflecting patterned surface 210 of the light guide 200 and exits the light emitting surface of the light guide 200. The light illuminates a target object and is reflected to the lens array 400 which focuses the light for sensors to capture an image of the target object.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A linear light source comprising:
a light guide comprising:
a light receiving end for receiving light emitted by a light emitting diode module;
a light reflecting patterned surface for reflecting light received through the light receiving end, the light reflecting patterned surface eliminating need for a reflective cover around the light guide;
a light emitting surface for emitting light reflected by the light reflecting patterned surface; and
a plurality of side surfaces disposed between the light emitting surface and the light reflecting patterned surface, at least two of the side surfaces for being grasped by a main housing to hold the light guide to the main housing.

2. The linear light source of claim 1, the light reflecting patterned surface comprising:
a plurality of peaks and a plurality of valleys, the plurality of valleys gradually increasing in depth away from the light receiving end of the light guide.

3. The linear light source of claim 1, the plurality of side surfaces comprising:
a side groove for holding the light guide by a side clip of a main housing;
a top groove for holding the light guide by a top clip of the main housing;
a right side surface disposed between the side groove and the light reflecting patterned surface, the side groove disposed between the right side surface and the light emitting surface;
a bottom side surface;
an angled side surface, the bottom side surface disposed between the light reflecting patterned surface and the angled side surface, the angled side surface disposed between the bottom side surface and the top groove; and
a left side surface disposed between the top groove and the light emitting surface.

4. The linear light source of claim 3, wherein the side clip extends into the side groove and grasps one surface of the side groove.

5. The linear light source of claim 3, the top groove comprising:
an obtuse angle notch, the top clip grasping one surface of the oblique angle notch.

6. The linear light source of claim 1, the light guide further comprising:
a hooded bracket disposed on the light receiving end of the light guide for holding a light emitting diode module to the light guide.

7. A linear light source comprising:
a light guide comprising:
a light receiving end for receiving light emitted by a light emitting diode module;
a side groove for holding the light guide by a side clip of a main housing;
a top groove for holding the light guide by a top clip of the main housing;
a light emitting surface for emitting reflected light;
a light reflecting patterned surface disposed on a side of the light guide between the side groove and the top groove for reflecting light towards the light emitting surface, the light reflecting patterned surface eliminating need of a reflective cover around the light guide; and
a plurality of side surfaces disposed between the light emitting surface and the light reflecting patterned surface.

8. The linear light source of claim 7, the light reflecting patterned surface comprising:
a plurality of peaks and a plurality of valleys, the plurality of valleys gradually increasing in depth away from the light receiving end of the light guide.

9. The linear light source of claim 7, the light guide comprising an elongated polygonal transparent material.

10. The linear light source of claim 7, the side groove comprising:
a two-sided notch disposed on a corner of the light emitting surface.

11. The linear light source of claim 7, the side groove disposed between the light emitting surface and one of the plurality of side surfaces.

12. The linear light source of claim 7, the side clip extending into the side groove and grasping one side of the side groove.

13. The linear light source of claim 7, the top groove comprising:
an obtuse angle notch, the top clip grasping one side of the oblique angle notch.

14. The linear light source of claim 7, the plurality of side surfaces comprising:
a right side surface disposed between the side groove and the light reflecting patterned surface, the side groove disposed between the right side surface and the light emitting surface;
a bottom side surface;
an angled side surface, the bottom side surface disposed between the light reflecting patterned surface and the angled side surface, the angled side surface disposed between the bottom side surface and the top groove; and
a left side surface disposed between the top groove and the light emitting surface.

15. The linear light source of claim 7, the light guide further comprising:
a hooded bracket disposed on the light receiving end of the light guide for holding a light emitting diode module to the light guide.

16. The linear light source of claim 15, the hooded bracket comprising:
a plurality of hood grasps for mating with module grasps of the light emitting diode module to securely hold the light guide and the light emitting diode module together.

17. The linear light source of claim 7, further comprising:
a printed circuit board for providing electrical power to the linear light source;
the light emitting diode module comprising:
a plurality of light emitting diodes;
a plurality of module grasps for holding the light emitting diode module to the light guide; and
a plurality of conductive pins for electrically coupling the plurality of light emitting diodes to the printed circuit board;
a main housing comprising:
the top clip;
the side clip; and
a light guide cavity, the light guide seated in the light guide cavity and the top clip and the side clip cooperating to hold the light guide in the light guide cavity;
wherein the printed circuit board is attached to a bottom surface of the main housing.

18. A linear light source comprising:
a light guide comprising:
a light receiving end for receiving light emitted by a light emitting diode module;
a side groove for holding the light guide by a side clip of a main housing;
a top groove for holding the light guide by a top clip of the main housing;
a light emitting surface for emitting reflected light;
a light reflecting patterned surface disposed on a side of the light guide between the side groove and the top groove for reflecting light towards the light emitting surface, the light reflecting patterned surface eliminating need of a reflective cover around the light guide, the light reflecting patterned surface comprising a plurality of peaks and a plurality of valleys, the plurality of valleys gradually increasing in depth away from the light receiving end of the light guide.
a right side surface disposed between the side groove and the light reflecting patterned surface, the side groove disposed between the right side surface and the light emitting surface;
a bottom side surface;
an angled side surface, the bottom side surface disposed between the light reflecting patterned surface and the angled side surface, the angled side surface disposed between the bottom side surface and the top groove; and
a left side surface disposed between the top groove and the light emitting surface.

19. The linear light source of claim 18, the light guide further comprising:
a hooded bracket disposed on the light receiving end of the light guide for holding a light emitting diode module to the light guide.

20. The linear light source of claim 19, the hooded bracket comprising:
a plurality of hood grasps for mating with module grasps of the light emitting diode module to securely hold the light guide and the light emitting diode module together.
